(19) United States
(12) Patent Application Publication
(10) Pub. No.: US 2007/0173394 A1
(43) Pub. Date: Jul. 26, 2007

(54) Paper cutting device with a cutting blade unit and a folding line maker

(76) Inventor: Chia-Shun Lee, Taoyuan County (TW)

Correspondence Address: Chia-Shun LEE, P.O. Box 44 - 2049, Taipei, 10668, TW

(21) Appl. No.: 11/397,577

(22) Filed: Apr. 5, 2006

(30) Foreign Application Priority Data
Jan. 24, 2006 (TW) 095201580

(51) Int. Cl. B26D 7/02

(52) U.S. Cl. 493/68; 83/614; 83/455

(57) ABSTRACT

A paper cutting device includes a guide member which is has one end pivotably connected to the base by a hinge and the other end of the guide member is positioned by two positioning rods. A box for receiving the spare cutting blades and the folding line makers is connected to the base. A cutting blade unit and a folding line maker are movably engaged with a groove in the guide member. The cutting blade of the cutting blade unit and the folding line maker can be replaceable. The cutting blade unit includes a protection case so that the cutting edge is hidden when not in use. The folding line maker has a dull edge which creates a folding line on the paper sheets.

### BACKGROUND OF THE INVENTION

1. Field of the Invention

The present invention relates to a paper cutting device including a cutting blade unit for cut paper sheets and a folding line maker which creates a folding line on the paper sheets.

2. Description of the Prior Art

A conventional paper cutting device generally includes a base with a cutting blade which is pivotably connected to the base and paper sheets can be put on the base and cut by pivoting the cutting blade. However, it is noted that the cutting edge of the cutting blade is exposed and does not have any protection device so that the cutting edge could hurt people. The blade is fixed on a frame so that when the blade becomes dull, the frame and the blade have to be both replaced. The cutting edge is located above the paper sheets so that the user cannot precisely control the initial contact point between the cutting edge and the paper sheets. The base generally has a fixed width which is not long enough to cut large size paper sheets. When the paper sheets are cut by the cutting blade, the sheets move slightly and the movement causes the paper sheets are not cut as desired. Besides, the conventional paper cutting device can only be used to cut paper sheets and does not have any other function.

The present invention intends to provide a paper cutting device that has a cutting blade unit which is movable along a guide member on the base to precisely cut the paper sheets. A folding line maker can also be moved along the guide member to make folding lines on the paper sheets.

### SUMMARY OF THE INVENTION

The present invention relates to a paper cutting device which includes a base having a front guide side and a rear guide side. A guide member is connected to a side of the base and a cutting blade unit and a folding line marker are movably connected to the guide member. The cutting blade unit and the folding line maker are replaceable. A box for storage of the cutting blade unit and the folding line maker is connected to the base. A foldable ruler unit is pivotably connected to the base and a hinge is connected to an end of the guide member. A lift bar is connected to the base so as to lift the guide member.

The primary object of the present invention is to provide a paper cutting device wherein the cutting blade unit includes a protection case to hide the cutting edge therein so that when the cutting edge does not hurt the users when not in use.

Another object of the present invention is to provide a paper cutting device which includes a folding line maker that has a dull edge for creates a folding line on paper sheets.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 is a perspective view to show the paper cutting device of the present invention;

FIG. 2 is a bottom view of the paper cutting device of the present invention;

FIG. 3 is a perspective view of the cutting blade unit of the paper cutting device of the present invention;

FIG. 4 is an exploded view to show the cutting blade unit of the paper cutting device of the present invention;

FIG. 5 shows a cross sectional view of the cutting blade unit of the paper cutting device of the present invention;

FIG. 6 is a cross sectional view to that that the cutting edge of the cutting blade unit is exposed when the protection case is pushed upward;

FIG. 7 shows another cross sectional view of FIG. 5 of the cutting blade unit of the paper cutting device of the present invention;

FIG. 8 shows another cross sectional view of FIG. 6 the cutting blade unit of the paper cutting device of the present invention;

FIG. 9 is an exploded view of the folding line maker of the present invention, and

FIG. 10 is a cross sectional view of the folding line maker of the present invention.

### DETAILED DESCRIPTION OF THE PREFERRED EMBODIMENTS

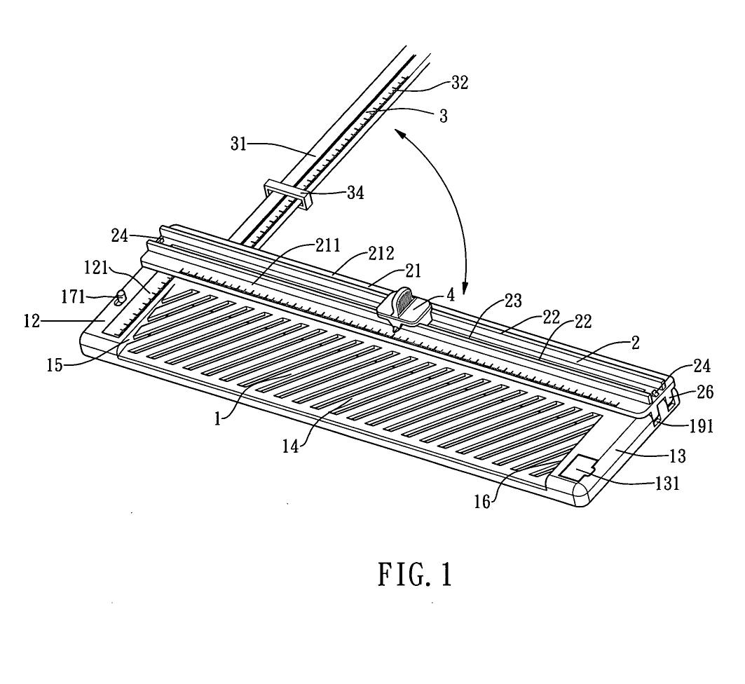

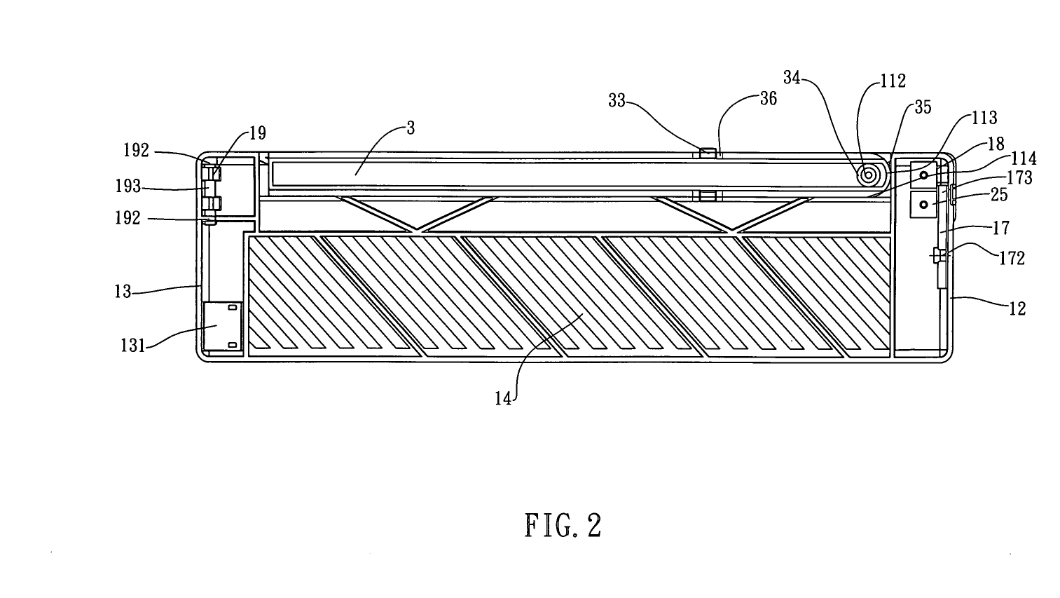

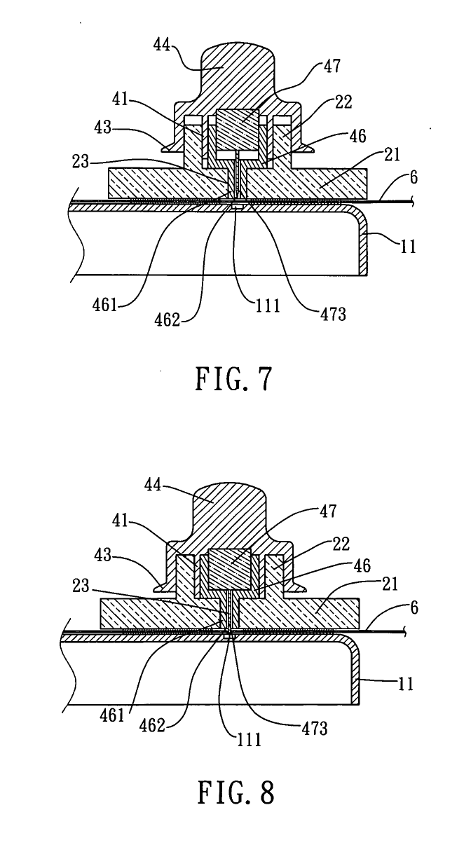

Referring to FIGS. 1 and 2, the paper cutting device of the present invention comprises a base 1 having a front guide side 15 and a rear guide side 16, a guide member 2 connected to a side of the base 1, a cutting blade unit 4 and a folding line marker 5 movably connected to the guide member 2. A support frame 11 (FIGS. 7 and 8) is located beneath the base 1. The base 1 includes an inclined top surface 14 which intersects a front end wall 12 of the frame 11 to define the front guide side 15, the inclined top surface 14 intersects a rear end wall 13 of the frame 1 to define the and rear guide side 16. Paper sheets 6 can be put on the inclined top surface 14 of the base 1 and two sides of the sheets 6 are guided by the front guide side 15 and the rear guide side 16. A box 131 for storage of the cutting blade unit 4 and the folding line maker 5 is received in an interior space of the rear end wall 13.

A lift bar 17 is received in the front end wall 12 and a button 171 is located on a top of the front end wall 12. When the button 171 is pushed, a lift rod 173 is pivoted about a pivot 172 and the lift rod 173 protrudes from the support frame 11 to raise a guide 21 of the guide member 2. There are scaling marks on the front end wall 12 and located close to the front guide side 15.

The guide member 2 has a hinge seat 26 connected to an end thereof so as to be pivotably connected to a hinge 19 of the base 1, the other end of the guide member 2 has a pair of positioning rods 25 which are engaged with two positioning holes 18 in the support frame 11. An opening 191 is defined in a side of the support frame 11 and a hinge base 192 is received in the support frame 11 so that a hinge pivot 193 is connected to a hinge seat 26 located behind the guide 21. The guide 21 has a groove 23 and the base 1 has another groove 111 so that the blade 473 of the cutting blade unit 4 is movable in the grooves 23 and 111.

The guide member 2 includes a guide 21 and both of the guide 21 and the rails 22 of the guide member 2 has a U-shaped cross section so that the cutting unit 4 can be moved linearly. The groove 23 is defined in the underside of the guide 21 and the protection case 461 of the cutting blade unit 4 is movably engaged with the groove 23. The guide 21 has a metric scale markings 211 and British scale markings 212 on two sides thereof. Two stops 24 are located on two ends of the guide 21 and located between the rails 22. In order to secure the guide 21 on the base 1, the guide 21 has a pair of positioning rods 25 on one end thereof and the other end of the guide 21 has a hinge seat 26 so as to be connected to the hinge base 192 by the hinge pivot 193.

A foldable ruler unit 3 is pivotably received in the space beneath of the support frame 11 and connected to a pivot 112 on a support frame 11 beneath the base 1 by ruler pivot 34. The foldable ruler unit 3 includes a ruler 31 on which scale markings 32 are provided so that the foldable ruler 3 can be pivoted outward to be perpendicular to the base 1. An indication ring 33 is movably mounted to the foldable ruler 3. A positioning protrusion 35 protrudes from an end of the ruler 31 and can be engaged with a first positioning notch 113 when in received position, and engaged with a second positioning notch 114 when being pivoted outward.

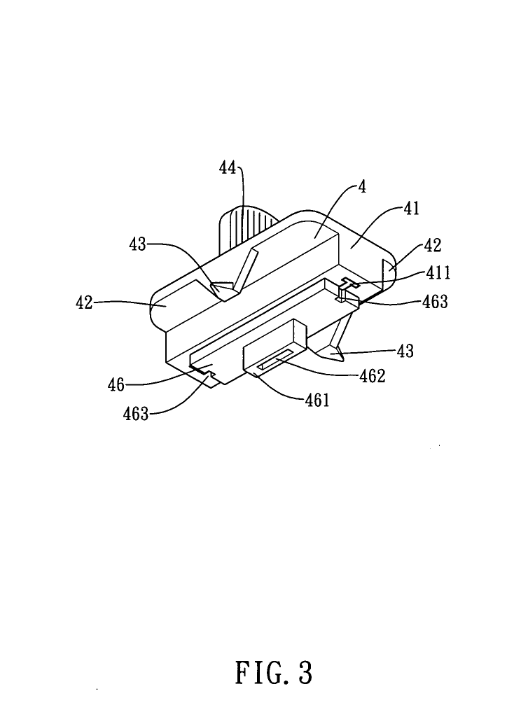

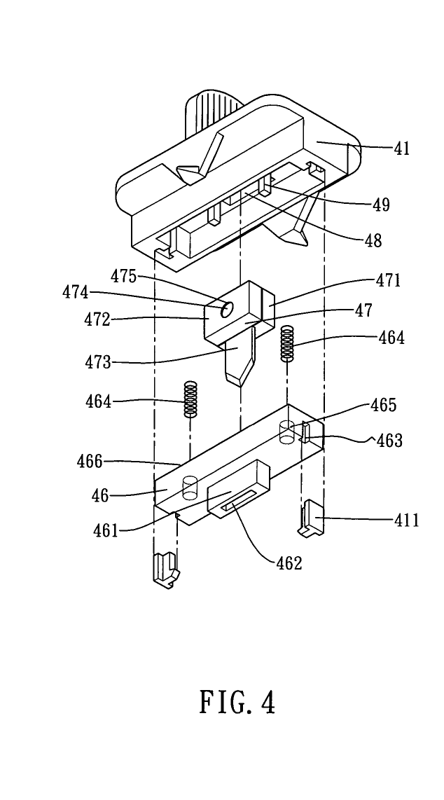

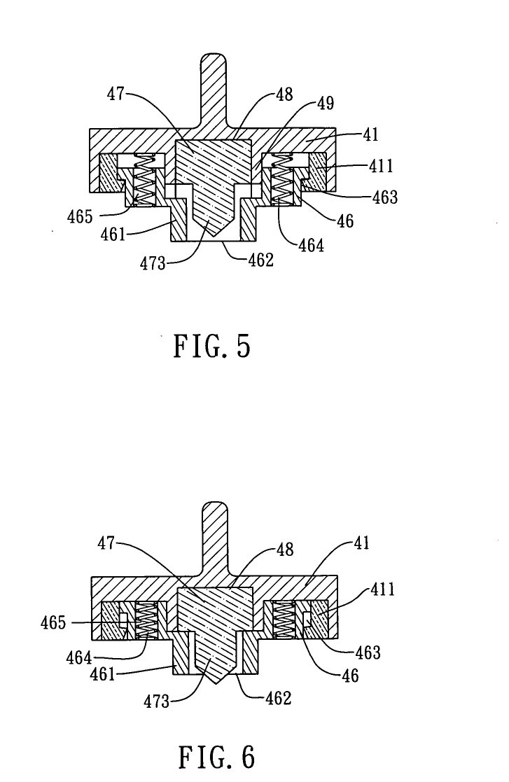

Referring to FIGS. 3 to 6, the cutting blade unit 4 includes a carrier 41, a flange 42 extending from the carrier 41, an indication point 43 perpendicularly connected to the flange 42, a handle 44 connected on a top of the carrier 41, a blade cover 47 and a blade protection member 46 which is retractably connected to a space 45 defined in the underside of the carrier 41. The blade protection member 46 are biased by springs 464 between the blade protection member 46 and the carrier 41. A protection case 461 is connected to the blade protection member 46 and includes a slot 462. The blade protection member 46 has positioning grooves 463 so as to be connected with the positioning pieces 411. The length of the positioning grooves 463 limits the travel of the protection member 46. The protection member 46 has a space 466 in which the blade cover 47 and the blade 473 are moved. The blade 473 has a through hole and is connected between the first half 471 and a second half 472 of the blade cover 47, wherein the first half 471 has a positioning pin 474 which extends through the through hole of the blade 473 and the positioning pin 474 further extends through a hole 475 of the second half 472. Two clamping rods 49 are located in the carrier 41 to further secure the blade cover 47. When the blade 473 is not in use, the blade 473 is enclosed by the protection case 461 and the protection member 46 is pushed by the springs 464. The positioning grooves 463 are engaged with the positioning pieces 411.

As shown in FIGS. 7 and 8, when paper sheets 6 are put on the top surface 14 between the support frame 11 and the guide 21, the blade protection member 46 is pushed to compress the springs 464 and the blade 473 protrudes from the protection case 461 and moves in the groove 111 to cut the paper sheets 6. The protection case 461 is moved in the groove 23.

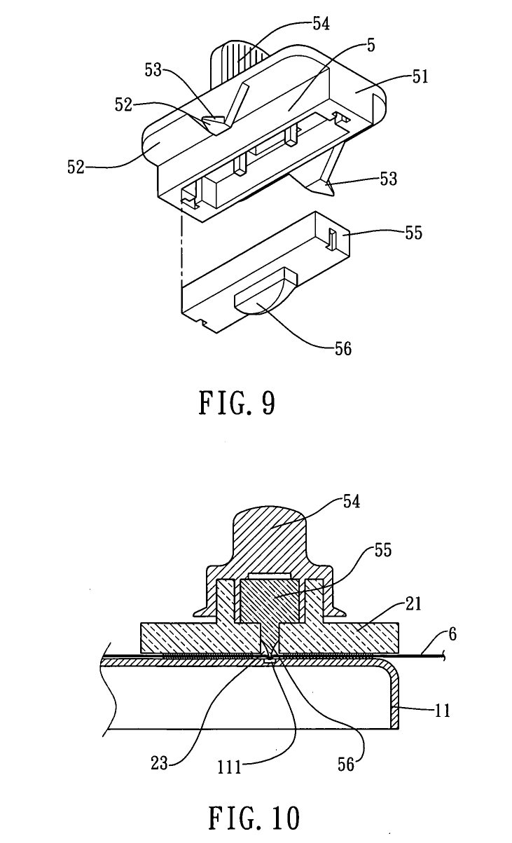

As shown in FIG. 9, the folding line maker 5 includes a carrier 51, a flange extending 52 from the carrier 51, an indication point 53 connected to the flange 52, a handle 54 connection on a top of the carrier 51, a protection case 55 connected to an underside of the carrier 51 and a marker 56. The marker 56 has a dull edge. The folding line maker 5 can be made by using the same molds for making the cutting blade unit 4 so that some parts are the same as the cutting blade unit 4. The dull edge of the marker 56 can create a folding line on the paper sheets 6.

An underside of the guide member 2 and a contact area between the base 1 and the underside of the guide member 2 are rough surfaces which prevent the paper sheets from being moved during cutting. The rough surfaces can be made by gluing a layer of paper, flexible material or making the rough surfaces to be knurled surfaces.

While we have shown and described the embodiment in accordance with the present invention, it should be clear to those skilled in the art that further embodiments may be made without departing from the scope of the present invention.

What is claimed is:

1. A paper cutting device comprising:
a base having a front guide side and a rear guide side, a guide member connected to a side of the base, a cutting blade unit and a folding line marker movably connected to the guide member, the cutting blade unit and the folding line maker being replaceable, a box for storage of the cutting blade unit and the folding line maker, and
a foldable ruler unit pivotably connected to the base, a hinge connected to an end of the guide member and a lift bar connected to the base so as to lift the guide member.

2. The device as claimed in claim 1, wherein the cutting blade unit includes a carrier, a flange extending from the carrier, an indication point connected to the flange, a handle connected on a top of the carrier, a blade cover and a blade protection member, the blade protection member is biased by springs between the blade protection member and the carrier, a protection case is connected to the blade protection member and the cutting blade is enclosed by the protection case when the springs are not compressed, when the blade protection member is pushed to compress the springs, the cutting blade unit protrudes out from the protection case, the cutting blade is replaced by removing the protection member and the blade cover, and by removing a first half and a second half

3. The device as claimed in claim 1, wherein the folding line maker includes a carrier, a flange extending from the carrier, an indication point connected to the flange, a handle connection on a top of the carrier, a protection case connected to an underside of the carrier and a marker, the marker has a dull edge.

4. The device as claimed in claim 1, wherein the foldable ruler is pivotably connected to a pivot on a support frame beneath the base and pivoted outward to be perpendicular to the base, the ruler includes metric scale markings and British scale markings, an indication ring is movably mounted to the foldable ruler, the ruler is pivoted about the pivot to be received beneath the support frame.

5. The device as claimed in claim 1, wherein the base includes an inclined top surface which intersects a front end wall of the frame to define the front guide side, the inclined top surface intersects a rear end wall of the frame to define the and rear guide side.

6. The device as claimed in claim 1, wherein the box is received in an interior space of the rear end wall.

7. The device as claimed in claim 1, wherein the guide member has a hinge seat connected to an end thereof so as to be pivotably connected to a hinge of the base, the other end of the guide member has a pair of positioning rods which are engaged with a first positioning notch and a second positioning notch defined in the support frame, a lift bar received in the front end wall and a button is located on a top of the front end wall, a lift rod is pivoted about a pivot when the button is pushed and the lift rod protrudes from the support frame to raise a guide of the guide member.

8. The device as claimed in claim 1, wherein an underside of the guide member and a contact area between the base and the underside of the guide member are rough surfaces.
